(19) United States
(12) Patent Application Publication
(10) Pub. No.: US 2009/0271333 A1
(43) Pub. Date: Oct. 29, 2009

(54) Method and System for Transactions Involving a Mortgage Product That is Backed by a Mortgaged Property and Additional Financial Instruments

(75) Inventor: Sam Payrovi, New York, NY (US)

Correspondence Address: WOLFF & SAMSON, P.C., ONE BOLAND DRIVE, WEST ORANGE, NJ, 07052, US

(73) Assignee: ProtEquity Group Inc., New York, NY (US)

(21) Appl. No.: 12/431,559

(22) Filed: Apr. 28, 2009

Related U.S. Application Data
(60) Provisional application No. 61/125,754, filed on Apr. 28, 2008.

(51) Int. Cl. G06Q 40/00

(52) U.S. Cl. 705/36 R; 705/35

(57) ABSTRACT

A method and system for creating and transacting a mortgage product that is backed by a mortgaged property and additional financial instruments. The mortgage product requires the determination of the value of a property to be purchased to be associated with an index for real estate in a region where the property is located, purchasing at least one put option contract on the index, and combining the contract with a loan to form the mortgage product. If there is a decrease in the index, the contract can be exercised so as to protect both mortgagor and mortgagee.

This application claims the benefit of Provisional Application 61/125,754 filed Apr. 28, 2008, which is incorporated by reference as though set forth herein in its entirety.

### BACKGROUND OF THE INVENTION

The weaknesses of currently available mortgage products have led to real estate declines and other related market turmoil via a cycle of individual borrowers' equity decline and resulting price declines in these markets through increased defaults. There are various types of protections for the borrower in a situation where the price of the property falls below the mortgage value, yet none of these methods of protection minimizes the increase in the Loan-to-Value (LTV) ratio of an individual mortgage by protecting equity in a manner that reduces the motivation to default.

One of these options is taught by U.S. Patent Application Publication No. US2007/0271163. This reference discloses a method for using options on housing futures contracts to offer home price insurance. This method is designed to protect both the borrower and the company issuing the insurance, though not the lender. The method involves using options on housing futures contracts to hedge claims risk and is directed to protecting the insurer from risk in issuing the insurance on home price to the borrower.

U.S. Patent Application Publication No. US2007/0299673 is directed to a back-end-loaded participatory real estate equity protection contract. This is intended to protect the property owner in that it gives him the right to receive compensation in the event of a decline in the real estate index of the metropolitan area where the property is located. The property owner can only exercise this feature upon sale of the property to a third party. The amount of compensation equals a proportion of the value of the property as appraised at or about the time of the purchase of the put option contracts, where the proportion is determined by the appropriate decline of a real estate market index.

U.S. Patent Application Publication No. US2004/0158515 describes another type of protection for a home owner against a decrease in home value. This reference provides protection with home asset value enhancement notes (HAVENS). These HAVENS require a separate business organization that collects the fractional ownership titles of a group of residential homes and bundles them as a single asset. The value of the asset is determined from local real estate regional price indices. Individual home owners can hedge their house investment to any level they deem necessary by shorting or purchasing the HAVEN notes on the open market.

U.S. Patent Application Publication No. US2004/0260578 describes real estate devaluation insurance in which an investor, upon sale of the property at a loss, is reimbursed the difference between a shelter value which was established in the insurance contract, and the sale price of the property.

U.S. Patent Application Publication No. US2006/008022 is directed to a home equity protection contract and a method for trading such contracts. A derivative instrument is created in the form of a contract that provides a cash-settled payout to the buyer at a pre-determined expiration date defined by the contract, correlated to the home's market value or home equity value and a reduction in value of a bench mark real estate index between the contract purchase date and the expiration date. These contracts are then securitized and sold to institutional investors to permit them to speculate in the value of residential real estate.

U.S. Patent Application Publication No. US2007/0192226 describes a system and method for providing a custom hedged adjustable rate mortgage. This system calculates a rate for determining the cost associated with a residential mortgage including a hedge, wherein the variables included in calculating the rate are percentage rates for loans, as well as the increase or decrease in the percentage for the loans.

A problem with the known protections, including those discussed above, is that they only protect specific parties involved in the mortgage and homeownership process; they do not protect all parties involved. For example, the vast majority of these existing products protect the borrower, while some also provide protection for an insurer issuing an insurance policy. However, none of the products, systems, or methods protect the mortgage's credit-worthiness (by minimizing LTV increase through equity protection), thus protecting both the borrower and the lender.

### SUMMARY OF THE INVENTION

Accordingly, one aspect of the present invention provides a set of mortgage products and a method for creating and selling the mortgage products through which both the borrower and the lender are protected in the event of a decline in home value as a result of regional housing price declines.

The inventive method, which protects equity in relation to a regional real estate market, has the added benefit of reducing defaults due to a mortgage's LTV ratio rising above 100%, otherwise known as going “underwater.” As participation in the inventive system increases in a given region, the magnitude and likelihood of market price declines in that region will be reduced due to the individual participants' diminished motivation to default. This in turn reduces the costs of the derivative products necessary to create these loans, making these new mortgages cheaper relative to their traditional counterparts, and thereby encouraging increased participation in a cycle that may lead to regional housing market stabilization.

With the method and mortgage product of the present invention, the borrower's mortgage is protected against regional real estate market declines by purchasing CME Housing Index put option contracts, which are traded on an exchange (e.g., the Chicago Mercantile Exchange (CME)) and making them the property of the mortgage account, similar to the property itself. The mortgage will thus be backed by a combination of the property and the put option contracts. Regional housing market put option contracts sold on other exchanges can also be used. While purchasing put option contracts protects against market declines and maintains the benefits of market appreciation, other derivatives (or combinations thereof) may also protect against market declines in a similar or slightly different manner. As is known, the CME is an exchange where futures and options are bought and sold between investors, speculators, market-makers, and other participants.

The CME Housing indices currently track the pricing trends of twenty real estate markets as well as two national indices. The regional markets are Atlanta, Boston, Charlotte, Chicago, Cleveland, Dallas, Denver, Detroit, Los Angeles, Las Vegas, Miami, Minneapolis, New York, Phoenix, Portland, San Diego, Seattle, San Francisco, Tampa Bay and Washington D.C. Each of these markets is in turn an accumulation of numerous counties. There are also two national housing indices: 1) an average of the initial ten housing markets that were tracked; and 2) a combination of all twenty housing markets.

The inventive product can also be created for borrowers who do not live in one of the 20 tracked CME Housing Index regions by using either of the two national indices. Furthermore, pursuant to the invention, commercial mortgage products can be created and sold to commercial real estate borrowers as a means to remove some real estate risk from their balance sheet and focus on their own business. The S&P/GRA Commercial Real Estate Indices (SPCREX) track commercial real estate pricing in relation to region (e.g., National, Northeast, Midwest, Mid-Atlantic South, Pacific West, or Desert Mountain West) and also in relation to type (office, warehouse, apartment, retail). A commercial real estate borrower's mortgage can be protected against price depreciation in relation to region and/or type of property using SPCREX put option contracts. The put option contracts that are sold on the indices are done so with an upfront fee at an agreed strike price.

Generally, this process would involve purchasing put option contracts with the strike set to the current index price. In effect, the buyer is paying an upfront fee in order to gain a return should the index price be below the strike price (current index price), thereby purchasing protection against the market declining (according to that region's CME Housing Index). It is also possible that the put option contracts can be purchased at a strike price below the current price, or “Out of-The-Money” (OTM) to reduce costs. In this embodiment, the borrower would not be protected for a small portion of the initial market depreciation, but would be protected beyond or below the strike price of the put option contracts. This would allow for a small, but limited increase in LTV in the case of market depreciation before the borrower's LTV is protected against increasing.

The amount of protection can also be limited to a certain portion of the initial decline in order to reduce costs. For example, the equity protected mortgage can be structured such that the protection provided only protects the first 25% of decline below the strike price. If the index declines 30% below the strike price, the borrower would only be protected for the first 25%, and not for anything beyond that. Thus, the borrower could recoup their losses on the first 25% of the decline, but would still experience a 5% equity loss.

CME Housing put option contracts are presently only exercisable on the expiry date (European style exercise). If the borrower terminates the mortgage contract by selling or refinancing or if the lender is selling the property due to the borrower defaulting, the put option contract s can be sold for their market value. This market value may not correlate to the decline in the index price. As the time to expiry nears, this difference dissipates. Additionally, it is possible that mortgage lenders and/or brokers can agree to cover this difference in exchange for taking any surplus. Furthermore, one of ordinary skill in the art would understand that the present invention could be readily practiced using options that can be exercised at any time (American style exercise), thereby removing this difference in intrinsic value and market value before the expiry date.

Currently, there is no program employing any such hedging techniques at the individual mortgage level. An individual seeking to purchase a home or commercial property can currently purchase these same put option contracts independent of their mortgage in order to hedge the value of their property, but this does not remove the motivation to default if the mortgage's LTV rises to or above 100% as the mortgage itself is not backed by the put option contracts. A borrower who does so can collect any value these put option contracts may have, but still has every reason to default on a mortgage that is underwater due to market depreciation. Furthermore, the cost to hedge, especially on such an individual basis, is far too great. Alternatively, lenders, banks, and other mortgage creditors can hedge their portfolios of mortgage debt and other risks by hedging using these same products. This, again, does not remove the individual borrower's motivation to default, and therefore does not provide any method of market stability.

Thus, the present invention provides a mortgage product that includes put option contracts that protect the borrower as well as the lender against a decline in the market value of the property by becoming the property of the mortgage itself.

In accordance with a further aspect of the present invention, a computer system and network for communicating, pricing, and settling the put option contracts and other associated agreements for the mortgage product of the present invention is provided. The trading system can receive a request for a mortgage product that identifies details concerning the mortgage, such as the purchase price of the property, the region of the property, and the desired level of protection. The system can further obtain relative pricing and availability of put option contracts for the real estate market. The system can calculate the number of put option contracts necessary to provide the minimum or desired level of protection based on various factors. The necessary put option contracts are purchased, and the put option contracts providing the desired level of protection are combined into the mortgage product of the present invention.

Other features and advantages of the present invention will become apparent from the following description of the invention.

### BRIEF DESCRIPTION OF THE DRAWINGS

The foregoing and other features of the present invention will be more readily apparent from the following detailed description and drawings of illustrative embodiments of the invention in which:

FIG. 1 is a flow diagram depicting the basic process of creating and using the inventive mortgage product, in accordance with an embodiment of the present invention;

FIG. 2 is an exemplary graph comparing a Loan-to-Value (LTV) ratio of a traditional mortgage with the inventive mortgage product, in accordance with an embodiment of the present invention;

FIG. 3 is a table comparing the LTV ratio of a traditional mortgage with the inventive mortgage product as a function of linear market appreciation and depreciation, in accordance with an embodiment of the present invention;

FIG. 4 is a table comparing the LTV ratio of traditional mortgage with the inventive mortgage product in a real-life example, in accordance with an embodiment of the present invention;

FIG. 5 is an exemplary network environment for supporting and executing transactions of the inventive mortgage product in accordance with an embodiment of the present invention;

FIG. 6 is a flow diagram illustrating a process for creating an offering of an equity-protected mortgage in accordance with an embodiment of the present invention; and

FIG. 7 is a flow diagram illustrating a process for transacting purchases for an equity-protected mortgage in accordance with an embodiment of the present invention.

### DETAILED DESCRIPTION OF THE INVENTION

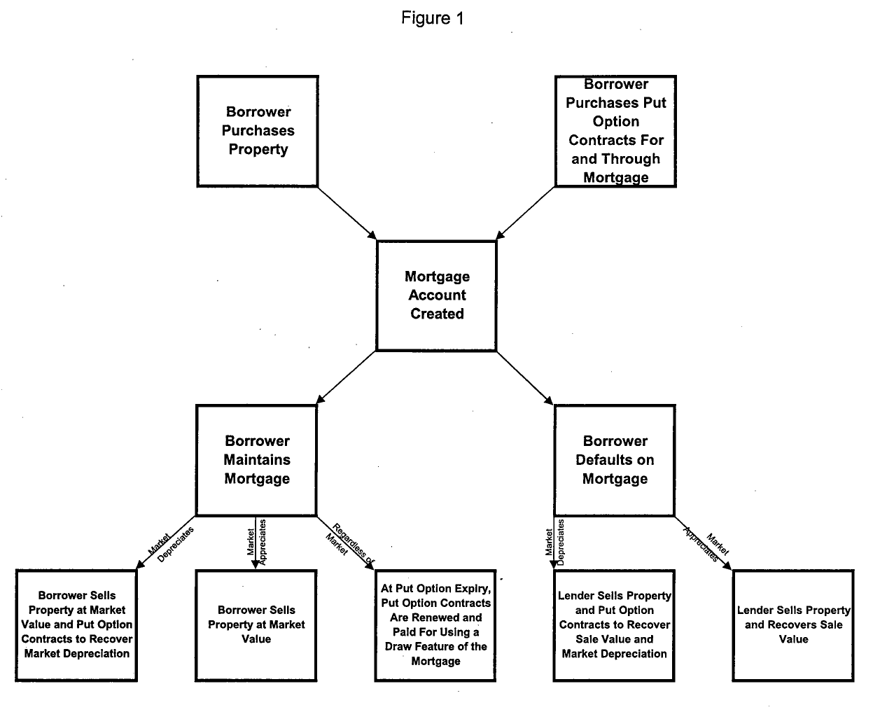

As shown in FIG. 1, the lender enters an order and purchases a number of put option contracts in order to approximately hedge the value of a property at the time of purchase. These put option contracts are then placed into the same mortgage account as the property and back the mortgage in a similar manner to the property itself. The presence of the put option contracts in this mortgage account protects against the depreciation of the regional real estate market in that, should the regional real estate market index fall below the strike price they were purchased at, the put option contracts appreciate in an amount that is relative to the depreciation of the property that backs the mortgage. As the LTV ratio is now calculated by dividing the loan balance by the sum of the property value and the put option contracts value, it is stabilized as the depreciation in the property value is offset by the appreciation in the put option contracts. Therefore, the mortgage contract is constructed to remove the incentive to voluntarily default by stabilizing the LTV against increase in a depreciating market, thereby protecting and benefiting both the lender (i.e., the loan originator or the subsequent owner of the loan) and the borrower against a drop in property values.

The put option contracts can include put option instruments that are purchased and placed in a mortgage account. However, purchasing put option instruments and placing them in the mortgage account typically require the purchase of a whole number of put option instruments. Thus, because fractional options cannot be purchased, it may not be possible to provide a specific level of protection. Alternatively, the put option contract may represent a right (i.e., a put option contract right) to exercise a number of put option instruments totaling a predetermined amount. The put option instruments backing the put option contract can be held in a trust that is contractually liable to the mortgage account for a specified number of put option instruments. It should be noted that put option rights to put option instruments held in trust allow borrowers to purchase fractional shares of put option instruments, thereby providing for the purchase of any level of protection.

The initial real estate property value is linked to the price of an index (i.e. the CME Housing Index in which the property is located near or in) at the time of purchase of the property. Thus, the real estate property value that is used to track appreciation/depreciation of the property is a function of the regional real estate market (“regional equity”). By using the index as the determination of value, factors such as property neglect, upgrades, changes in neighborhood, etc. (“non-regional equity”), are generally excluded from the calculation of property value. In this way, contract pricing and payout are linked only to the regional real estate market according to the CME Housing Index for that region. This allows the property owner to collect on regional real estate market depreciation upon a sale or refinancing. Furthermore, they can do so without having upgrades or any other appreciation to the property mask the market depreciation, as a decline in the index will still result in payout, regardless of the actual sale price of the individual property. Also, this will allow the lender to collect on any market depreciation in case the borrower defaults on the mortgage, providing for a higher recovery value for the mortgage debt itself. This methodology provides for an exact tracking of the property value for this purpose.

In theory, there is no limit to the amount of protection that can be obtained. However, in general, the limit would be the property value at the time of purchase. Current limitations and availability of put option contracts allow for a pre-determined contract length, currently available for up to 5 years. Eventually, as longer contracts become available, it is possible that they will be used if they fit the needs of the borrower (according to price and expectant length of ownership). However, as the time period for the contract may increase the cost, this may result in the cost of the contract being prohibitive.

As the contracts expire, new contracts can be purchased in order to continually stabilize and maintain a maximum predetermined LTV of the mortgage. This can be done through two methods. The cost of the new contracts necessary can be raised through an optional draw feature of the mortgage that will increase the principal balance (and thus LTV) by a small amount. The lender will deposit this difference into the account, which will then be used to purchase the put option contracts. Alternatively, the borrower maintains the option to pay for the put option contracts by making a deposit into the account. Any combination of the two methods can also be employed. In regards to the expiring contracts, if the current index price is below the strike price on the expiry date, the put option contracts have an intrinsic value and they will be exercised for cash that will be deposited into the mortgage account. The mortgagor can purchase put option contracts at the new lower current index price, but must leave the remaining amount of cash in the mortgage account. Alternatively, this cash can be used to assist in buying new put option contracts at the previous strike price, which will effectively maintain the LTV in a similar manner to leaving the cash in the account. Any combination of put option contracts at a certain strike price and cash left in the account can be executed if it maintains the LTV. If the market has appreciated, the borrower can choose to purchase put option contracts with the strike set at the current index price to lock-in the gained regional equity of the property. Instead, the borrower can also purchase put option contracts with the strike set at the previous strike price for a lower cost, but would forego locking-in the equity gained. They can also be purchased anywhere between the old strike price and the current index price.

Furthermore, at any time before the expiry of the contracts, the borrower can choose to sell the put option contracts and purchase new ones if doing so would maintain protection from the original strike price to the current market price through a combination of the new put option contracts and a sum of cash left in the account. Any surplus of cash is at the discretion of the borrower to pay down principal or take out of the account as a withdrawal. This could be done to extend the length of protection at a time when put option contracts are low in cost.

In another embodiment of the invention, there is the possibility of the property owner purchasing protection at a later time, for example during a refinance or when obtaining an equity loan against the property.

Furthermore, if at any time the regional index has appreciated before the contracts' expiry, the borrower can choose to lock-in any portion of the gained regional equity in a similar manner to renewal at expiry. This can be done by selling the existing put option contracts for cash and purchasing new put option contracts at a higher strike price.

In addition to the benefits to the property owner and lender mentioned above, there is the additional advantage that a borrower can take out non-regional equity (i.e., the total equity gained minus the regional equity according to the index) without increasing the principal balance of the mortgage. At any time, the borrower can have their individual property assessed. If the sum of the assessed property value and the value of the put option contracts provide an LTV lower than the previous locked-in LTV, the borrower can choose to sell the put option contracts and purchase new ones at a lower strike price (and also at a lower cost than what the previous put option contracts were sold for) that would maintain the locked-in or previous LTV. This will result in an excess of cash in the mortgage account which roughly represents the individual's property non-regional equity. The borrower has the option to take this cash out of the account as an equity withdrawal. This new form of equity withdrawal does not increase the mortgage's principal balance (as is the case in current traditional mortgages that allow for equity withdrawal). Thus, a new method of taking out equity is provided.

In addition to the benefits to the property owner and lender mentioned above, there is the additional advantage that the mortgage can be offered at a lower interest rate due to the security provided by the put option contracts backing the mortgage. The lender is protected in several ways. For example, the put option contracts diminish the likelihood of a situation where the LTV ratio rises to and above 100%, thus motivating the borrower to default, thereby increasing the mortgagor's credit quality. Additionally, in the unlikely case of default the lender is afforded any benefit of the put option contracts, which they can sell upon foreclosure of the property to recover any market depreciation that the property may have experienced. Furthermore, as the LTV ratio decreases through principal paydown or market appreciation, it is possible to incrementally reduce the mortgage interest rate.

There are various ways to pay for the initial put option contracts which can be considered a closing cost. For example, the cost could be paid in cash in full at closing. Alternatively, the cost of the contract can be paid for by the lender through the mortgage account for a small increase in principal balance and LTV. A further option is to include a built in draw feature into the loan so that future costs for purchasing new option contracts, for example, every two to five years, would automatically be taken as a draw and increase the principal balance of the mortgage, as described previously.

The put option contracts, in addition to being exercised at the end of their lifespan if they have any value, can also be sold upon sale of the property or upon refinancing to recover any market depreciation the property may have experienced. Thus, the property owner and the lender are both protected throughout the life of the contract, not just at the expiration date, since the contracts can be sold previous to their expiry date, i.e. at any time the index falls below the strike price, they have an intrinsic value. Furthermore, when the option contracts are exercised, they are paid in cash, thereby removing the need to sell an “exercised into” contract to collect cash.

Alternatively, if the market index has declined and the put option contracts are exercised into cash at their expiry, after purchasing new put option contracts at the new lower strike price, the borrower and lender can opt to use the remaining cash to pay down the principal balance of the loan instead of leaving it in the mortgage account. This method can be opted for if it maintains the maximum predetermined LTV. Paying down the principal balance of the loan is another method of maintaining the LTV ratio. Thus, instead of maintaining enough assets in the mortgage account by a combination of property, put option contracts, and cash (i.e., maintaining a sufficiently large denominator of the LTV formula to prevent it from rising), the borrower can pay down the principal of the loan, thereby reducing the numerator of the LTV formula. The added benefit of paying down the principal is that the borrower can pay interest on a much lower balance. The borrower can still be provided with the option to maintain some or all of the cash in the account, as it can be used, for example, to lock in future equity gains. Thus, in this way the problem of high balances on low property values is addressed.

Since the mortgages are protected against real estate market declines, they become a more attractive product for packaging and securitizing in financial markets. This increased demand will result in increased price in the secondary markets for mortgages, and increased price will lead to the lower interest rate for borrowers, as described in above.

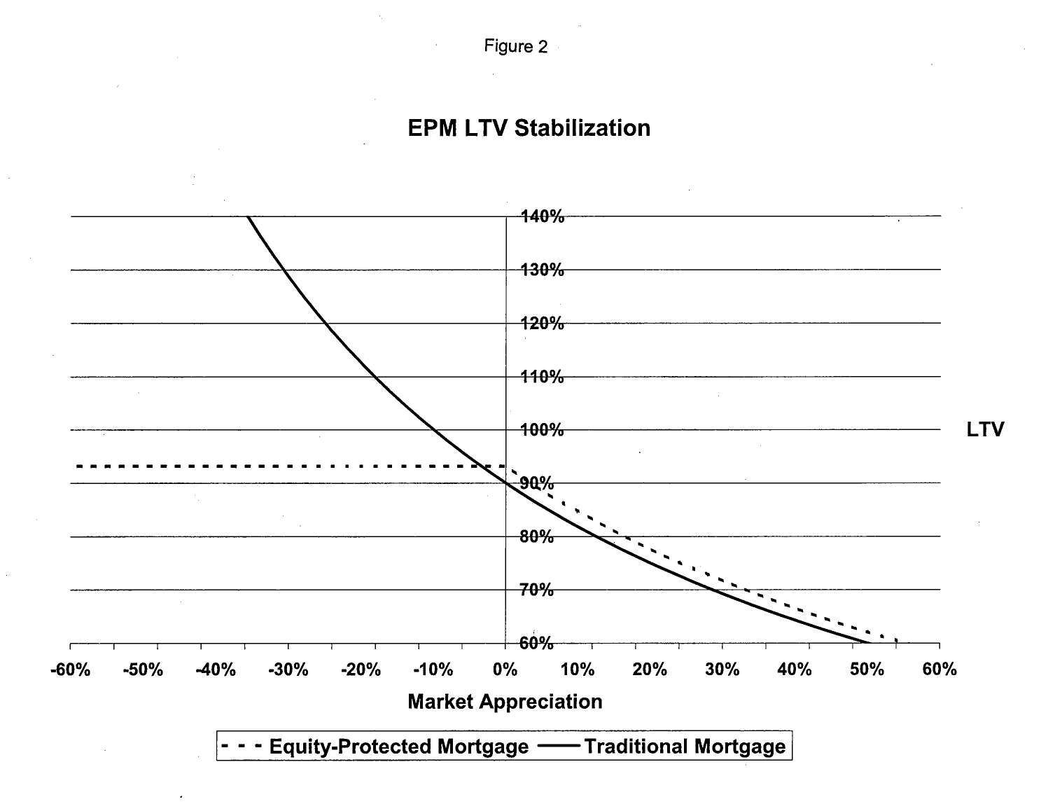

FIGS. 2-4 will next be described to compare the present invention to a traditional mortgage. All the information represented in FIGS. 2-4 is based upon the assumption that the loans are interest-only and no principal is paid. This simplifies the calculations for the purposes of comparison of the invention to traditional mortgages. However, it should be understood that a comparable equity-protected mortgage (EPM) pursuant to the present invention can be created for virtually every type of previously existing loan, (i.e. it does not have to be simply a 30 year fixed or an interest only loan).

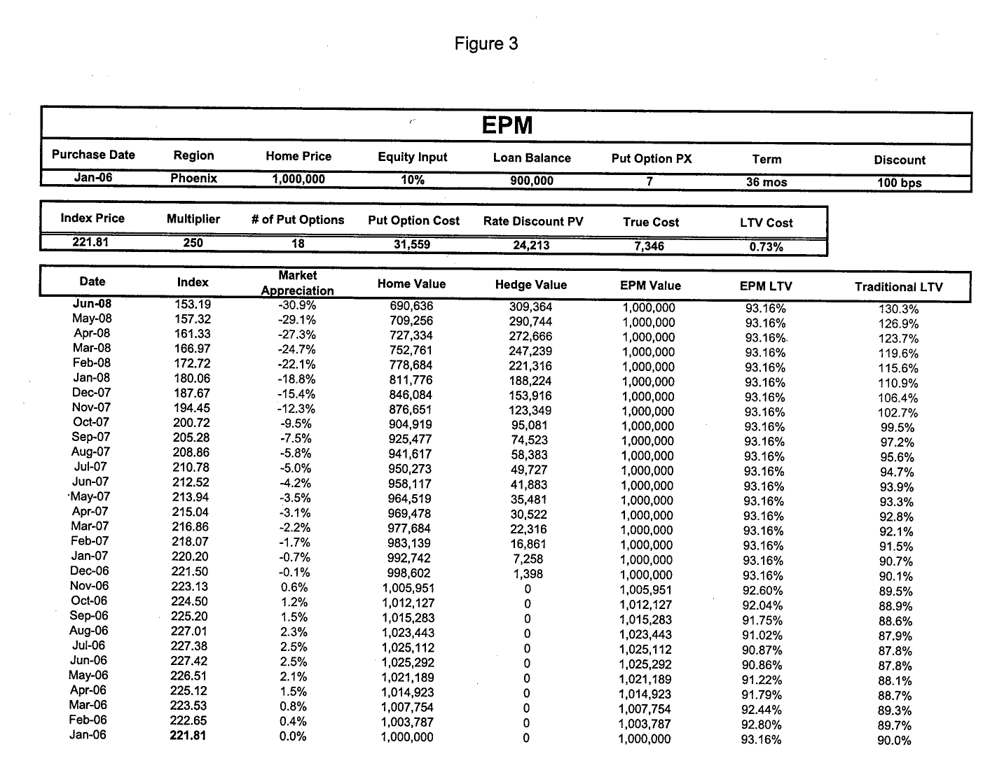

FIG. 3 is a table that demonstrates how the equity-protected mortgage of the present invention functions and could be used to prevent or divert a housing mortgage crisis (e.g., the sub-prime mortgage crisis) by reducing defaults. As previously mentioned, this is based on an interest only loan, however, the principles would be equally applicable to other types of loans. In this example, the home was purchased in Phoenix, Ariz. in January, 2006 at a price of $1,000,000 with a 10% down payment (Equity Input for a Loan Balance of $900,000). The Index Price at the date of purchase was 221.81. In this example the index rises from its initial value, the home appreciates, and the Loan-to-Value ratio (LTV) declines for both the equity-protected mortgage as well as the traditional mortgage. However, when the index drops to below its original value (in December 2006) it can be seen that while a traditional mortgage's LTV climbs above its initial value of 90% and eventually beyond 100% (going underwater), the LTV of the equity-protected mortgage of the present invention does not go above its original value (93.16%). Although the original Equity Input was 10%, the initial LTV is 93.16% due to the cost of the put option contracts (3.16% LTV points).

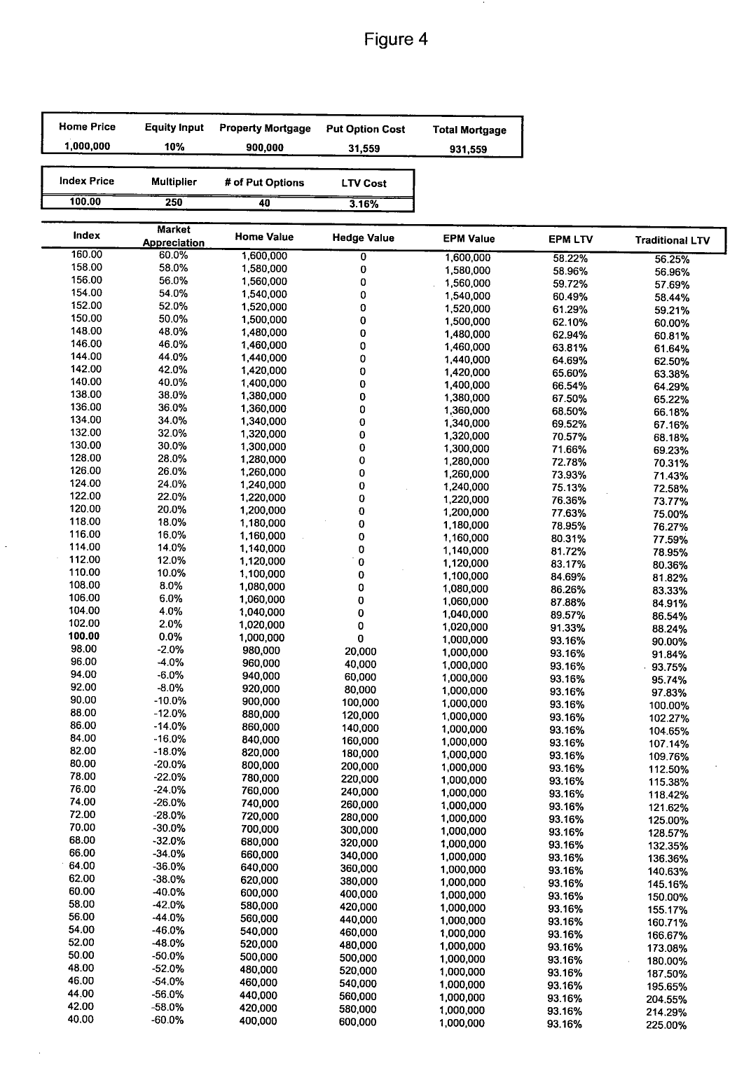

FIG. 4 is a table showing a comparison of the LTV of the equity-protected mortgage (EPM) of the present invention to a traditional mortgage as a function of the index using the same $1,000,000 home value and $900,000 Loan Balance as utilized in the example of FIG. 3. Starting with an assumed index of 100 at the time of purchase, as the index increases the home value also increases, which in turn causes the LTV of both the traditional mortgage and the mortgage of the present invention to decline. However, when the index decreases (representing market depreciation), the LTV of the traditional mortgage increases quickly to, and over, 100%. In the equity-protected mortgage of the present invention, however, due to the put option contracts that also back the mortgage, the LTV never exceeds the amount it was on the date of purchase of the home, e.g., 93.16% in the present example.

FIG. 2 graphically shows the change in LTV relative to a percentage change in market value. This graph clearly shows that the inventive equity-protected mortgage operates to cap the LTV ratio at its original value and therefore maintain it below 100%. This virtually eliminates the incentive for a borrower to default on their mortgage due to declining home prices. However, even if that should occur, the lender is protected by the put option contracts of the mortgage and can recover any market depreciation the property had experienced.

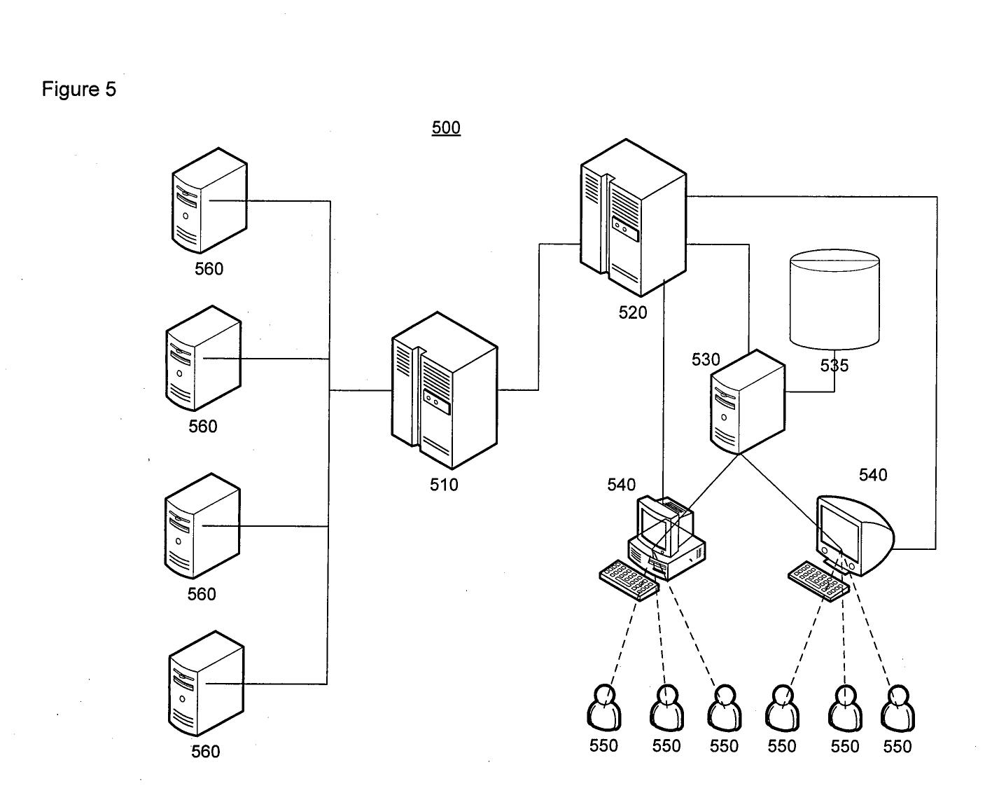

The foregoing discussion regarding equity-protected mortgages and their creation, transaction, and conversion are preferably performed within a networked computer environment. FIG. 5 illustrates an exemplary network environment 500 for supporting and executing transactions involving the equity-protected mortgage product described above.

The network environment 500 includes a server (or set of servers) that comprise the market exchange server 510 (e.g., the Chicago Mercantile Exchange) on which put option contracts can be traded. The exchange server 510 is connected to various brokerage seller servers 560. The exchange server 510 is also connected to a protected equity brokerage server 520 that is configured to buy and sell put option contracts on real estate indices for various geographic areas. The protected equity brokerage server 520 is in network communication with an equity-protected mortgage trust server 530 that is preferably connected to a computer data storage device such as database 535. The database 535 preferably stores information related to a portfolio of put option contracts that are held by the equity-protected mortgage trust server 530 as well as the put option contracts between the equity-protected mortgage trust server 530 and mortgagors 550. In one embodiment of the present invention, the protected equity brokerage server 520 and the equity-protected mortgage trust server 530 operate within a common system or server (i.e., an equity-protected mortgage trading system).

The equity-protected mortgage trust server 530 preferably communicates with various mortgage brokers or mortgage lender servers 540. Additionally, the equity-protected mortgage trust server 530 can communicate directly with mortgage lenders 540, for example to provide put option contract pricing and availability information. That is, the equity-protected mortgage broker server 520 can examine the exchange server 510 to gather information on available put option contracts. The published put option contract prices can be based in part on the index price, the length of the put option contract, and the volatility of the respective real estate index. The information can then be processed and published to mortgage lender servers 540, as available put option contract prices for real estate index prices in a particular region.

Mortgagors 550 typically communicate with mortgage lender servers 540 by offline means (e.g., telephone, fax, letter correspondence, or face to face conversations), and therefore such communications are represented in FIG. 5 by dashed lines.

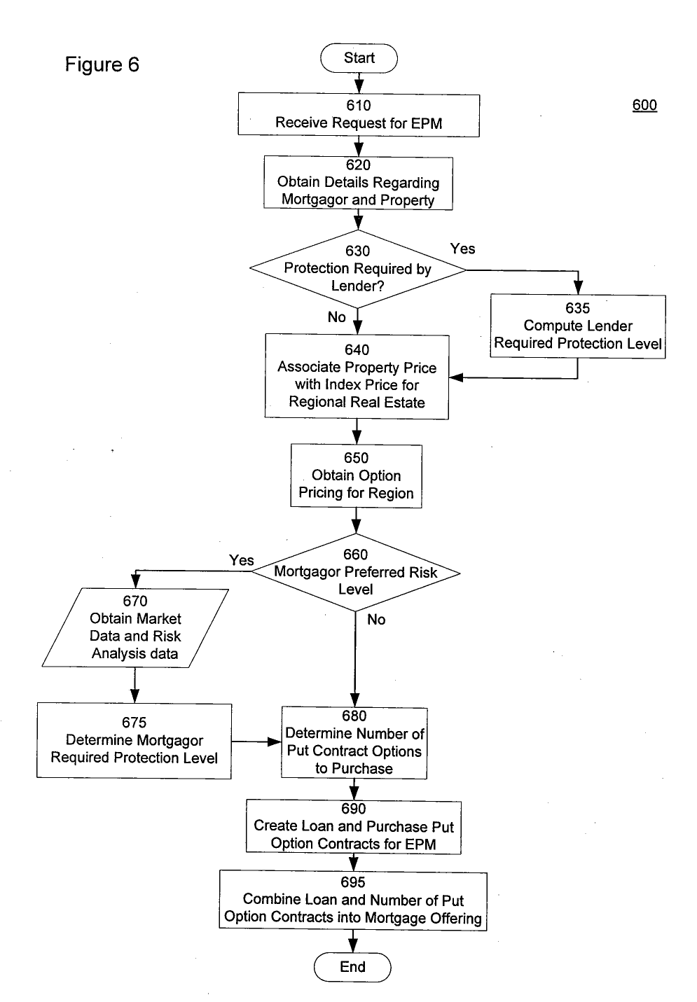

As discussed in detail below with respect to FIG. 6, the mortgage lender system server 540 is preferably configured to gather information regarding prospective mortgagors and property, minimum and increased desired levels of protection against real estate market decline, and market activity. It is also configured to obtain updated available volume and pricing of real estate put option contracts from the protected equity brokerage server 520. This information can then be analyzed to determine available equity-protected mortgage products that can be offered and are suitable for particular mortgagors 550 and mortgage lender servers 540. The mortgage lender server 540 can further communicate with the equity-protected mortgage trading system to transact sales of equity-protected mortgages.

Each of the mortgage lender system server 540, equity-protected mortgage trust server 530, protected equity brokerage server 520, market exchange server 510, and brokerage seller servers 560 can include conventional computer components and architecture including a processor, network interface, storage device, and other computer readable medium, including but not limited to RAM, ROM, hard disks or other electromagnetic storage, optical discs, network attached storage device or other external storage device, and flash memory devices. The computer readable medium is encoded with a computer program that can be executed by the computer system.

FIG. 6 illustrates a process 600 for processing requests for equity-protected mortgages, optionally at a mortgage lender system server 540. The process 600 can be implemented and executed by a computer program encoded in the computer readable medium of a server, the hardware of the server (e.g., the hardware discussed above but not limited thereto), or a combination and cooperation of hardware and an encoded computer program.

More specifically, at step 610, the mortgage lender server 540 receives a request from a prospective mortgagor 550 or agent acting on behalf of the mortgagor 550. The request for the equity-protected mortgage at step 610 optionally includes a specified level of equity protection desired by the mortgagor and additional information about the desired parameters for the equity-protected mortgage. For example, the request preferably indicates the price of the property being purchased, the size of the mortgage being made and/or the down-payment being made. If the additional information concerning desired parameters is not included, the system can query the requestor for any necessary additional information.

At step 620, data regarding the details of the property and the mortgagor can be obtained and analyzed. For example, information concerning the mortgagor's credit score, credit history, previous mortgages, or other assets can be obtained. Preferably, this information is obtained by the mortgage lender system server 540 through communications with third party servers that perform background checks and report credit scores. Additionally, details concerning the size, location, surrounding area, and history of the property can be obtained and analyzed.

Because the mortgagor is not the only party assuming risk in a mortgaged property transaction, it may be desirable for the lender to require the mortgagor to purchase a certain level of equity protection. At step 630 it is determined whether the lender requires the mortgagor to purchase a certain level of protection by purchasing put option contracts. If the lender requires protection, at step 635, the required level of protection is computed. The computation is based on the details concerning the mortgagor and the property obtained at step 620 and data concerning market and risk analysis (e.g., market volatility, trends, forecasts, etc. . . . ). Based on the gathered information, the lender can quantify the risk associated with the particular mortgagor and the specific property, and compute a minimum level of equity protection for the mortgagor's risk level.

For example, a lender may perceive a mortgagor with a low credit score may be a high risk of default, and would therefore require additional equity protection be purchased to decrease the mortgagor's incentive to default if the market declines. In a more specific example, a borrower with a lower credit score may require protection against the first 35% of market decline whereas a borrower with a higher credit score may only require protection against the first 20% of market decline. Additionally, the lender can factor into the computation information about the location of the property, such as whether it is in an increasingly popular area, an area experiencing gentrification, or an area in decline, for example, due to a loss of jobs. A lender may require the purchase of additional equity protection in an area in decline, or less equity protection in an area that is perceived as unlikely to experience a market decline. In another example, a borrower may require lower levels of protection if the property is in a neighborhood/city that has lower price volatility relative to the larger regional market or is fairly resistant to market declines, and vice-versa.

The property value is then associated with the current index price for real estate in the area where the property is located at step 640. The lender can then obtain available option volume and pricing information at step 650.

After the minimum level of protection required by the lender has been determined, or if no lender protection is required, at step 660 the system can optionally determine whether a mortgagor has indicated a preferred risk level or desire to purchase additional protection. The risk level can be specified as a combination of percentage of market decline (e.g., protecting against the first 20% of market decline) and how much market depreciation can be withstood before the protection starts (whether protection needs to protect against immediate index declines, or after the first 5%, 10%, or 15% of index decline). Alternatively, the risk can be specified by a rating such as low, medium, high, and/or a sell by date such as 5 years, 10 years, or 15 years. At step 670, the mortgage lender system server 540 can obtain information concerning market data and risk analysis data (e.g., market volatility, trends, forecasts, etc. . . . ) if it was not already obtained at step 620. Based on the data obtained at step 620 and 670, and based on the mortgagor's preferred risk level, the lender can compute the mortgagor's required protection level at step 675.

At step 680, the various computed equity protection levels (i.e., the mortgagor preferred risk level and/or lender required protection level) are used to determined a required number of put option contracts. That is, the mortgage lender system server 540 determines the minimum level of protection required, which is the largest of the various equity protection levels, and then determines the number of put option contracts required to provide the desired level of protection.

One of ordinary skill in the art would understand that the typical level of equity protection would protect between the initial 20% and 50% of immediate market depreciation. The cost associated with larger percentages of equity protection can become a significant financial factor in the purchase of an equity-protected mortgage, and it is unlikely that a mortgagor would desire prohibitively high protection levels. Additionally, the term of the put option contracts can affect the desired level of equity protection as well as the cost of each put option contract.

If the terms of the equity-protected mortgage offering are accepted by the prospective mortgagor, the mortgage lender servers 540 can convey the order to the equity-protected mortgage broker server 520 and/or the equity-protected mortgage trust server 530, or the equity-protected mortgage trading system.

At step 690, the loan for the equity protected mortgage is then created and the required put option contracts are purchased. These put option contracts are combined with the loan at step 695 into a single equity-protected mortgage offering. The combination of the loan and put option contracts can be accomplished by placing a whole number of put option contract instruments in the same account as the loan for the mortgage. Alternatively, the put option contract instruments can be held in the equity-protected mortgage trust server 530, which will then be contractually obligated to the mortgage for a specific, and now possibly fractional, number of put option contract instruments. In other words, a specific number of put option rights are held in the same account as the loan for the mortgage, and the put option rights are backed by put option contract instruments that are held in trust by the mortgage trust server 530.

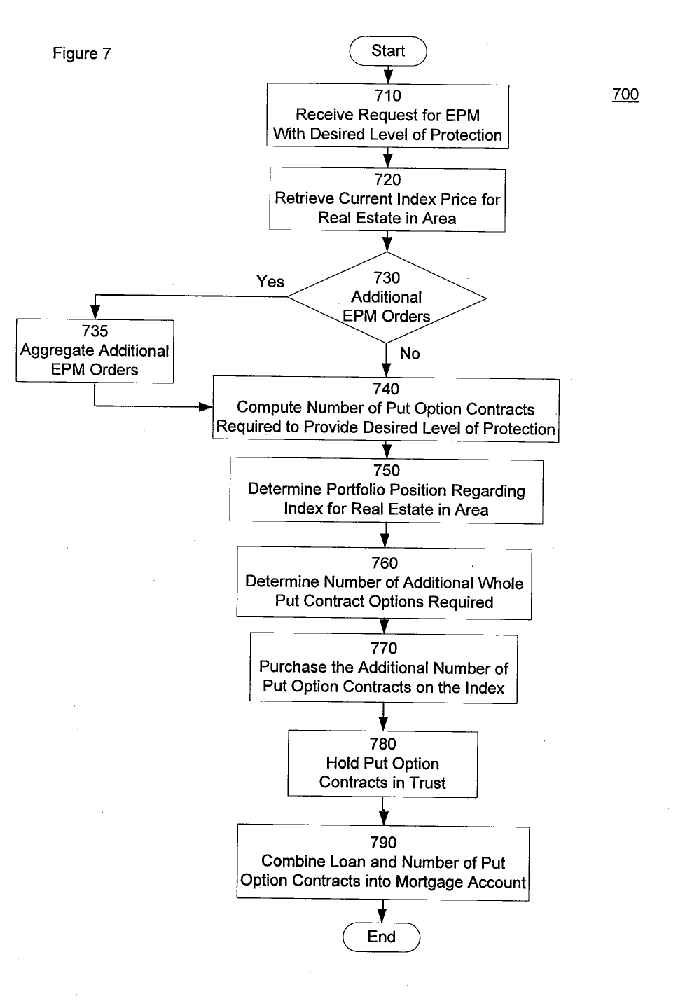

FIG. 7 is a flow diagram illustrating a process 700 for transacting purchases of an equity-protected mortgage at the equity-protected mortgage broker server 520 or preferably the equity-protected mortgage trust server 530 or a combination thereof. The process 700 can be implemented and executed by a computer program encoded in the computer readable medium of a server, the hardware of the server (e.g., the hardware discussed above but not limited thereto), or a combination and cooperation of hardware and an encoded computer program.

At step 710, the equity-protected mortgage broker system receives a request for an equity-protected mortgage having a desired level of protection. At step 720, the current index price for real estate in an area is retrieved based on information provided by the exchange server 510. Alternatively, mortgage lender server 540 can request an equity-protected mortgage that specifies a number of put option contracts for a particular real estate price index (i.e., the real estate price index in the area the property is located). Preferably, the equity-protected mortgage broker system receives a desired level or protection so that any fluctuations in the price of a put option contract can be adjusted for prior to execution of the trade.

The equity-protected mortgage broker or trust can examine a pending order list, preferably stored in a computer readable data store, for additional orders related to the same real estate price index, or the system can wait for a period of time to allow additional orders to be received. At step 730, the equity-protected mortgage broker server 520 determines if additional orders are present. If so, the orders are aggregated at step 735, such that the equity-protected mortgage broker server 520 has a total level of desired protection with respect to a particular real estate price index.

At step 740, based on the total desired protection level, and the price of a put option contract for the related real estate price index, a number of put option contracts is computed. It should be noted that providing a particular level (i.e., monetary sum) of equity protection to one borrower can require the purchase of a fractional put option contract. However, put option contracts can only be purchased on the exchange server 510 as whole units. Therefore, to provide an adequate level of protection, any fractional number of contracts must be rounded up. Thus, by aggregating orders for a particular real estate index and enabling borrowers to purchase a fractional number of put option rights that are backed by put option instruments held in trust at the equity protected mortgage trust server 530, borrowers can obtain the exact levels of protection they need and overall costs are minimized.

The trust maintains information regarding the put option contracts held in trust in the data store 535. In order to further minimize the number of additional put option contracts required to provide a desired level of equity protection, at step 750 the equity-protected mortgage broker server 520 can examine the number of put option contracts already held in trust for that region, term, and strike price, and the level of equity protection provided to other equity-protected mortgages. The equity-protected mortgage broker server 520 or the equity-protected mortgage trust server 530 can determine the fractional shares of put option contracts that are held in trust but not directly backing an equity-protected mortgage. The number of put option contracts required to be purchased to satisfy the new order can be reduced by the number of fractional shares of put option contracts that are held in trust but not directly protecting an equity-protected mortgage. Thus, the number of additional whole put option contracts required is computed at step 760. For example, a trust may hold 1001 put option contracts, of which 1000.5 are necessary to back existing equity-protected mortgages. If a new equity-protected mortgage enters a request that requires 100.3 put option contracts, the equity-protected mortgage broker server 520 will need a total of 1100.8 put option contracts, and therefore must purchase an additional 100 put option contracts for a total of 1101 put option contracts.

The required put option contracts are purchased over the exchange server 510 by the equity-protected mortgage broker server 520 at step 770 and placed in trust at step 780 with the equity-protected mortgage trust server 530. The loan behind the mortgage and the number of put option contracts are then stored in a single mortgage account associated with the mortgagor 550 at step 790.

Although the present invention has been described in relation to particular embodiments thereof, many other variations and modifications and other uses will become apparent to those skilled in the art. For example, one of ordinary skill in the art would understand that, while described with respect to put option contracts, the present invention could be practiced using various combinations of derivative products that protect against market declines.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

1. A method for creating a mortgage product, comprising the steps of:
associating the purchase price of a property to a current index price for real estate in a region where the property is located;
purchasing at least one put option contract on that index;
combining the contract and the property into one mortgage account to form the mortgage product; and
determining if there is a decline in the index, whereby if there is a decline the contract can be sold or exercised on the expiry date so as to protect both mortgagor and mortgagee against market depreciation and a likelihood of default.

2. The method according to claim 1, wherein the property value is determined from a real estate Index for a given region.

3. The method according to claim 1, wherein the index is a Chicago Mercantile Exchange Real Estate Index.

4. The method according to claim 2, wherein the purchasing step includes purchasing enough put option contracts so that a gain in value of the put option contracts when the index declines is commensurate to a regional equity decline in value of the property according to a percentage decline in the index for the region.

5. The method according to claim 1, wherein the step of combining the contract with a loan includes adding the cost of at least one put option contract to the principal amount of the loan.

6. The method according to claim 1, wherein the step of combining the contract with a loan includes classifying the cost of the put option contract as a closing cost to be paid at closing of the loan.

7. The method according to claim 4, further comprising the step of specifying a time period for which the put option contracts are in effect.

8. The method according to claim 1, wherein the purchasing step includes purchasing the put option contracts with a strike price set to the current index price.

9. The method according to claim 7, further comprising purchasing new put option contracts as the original contracts expire.

10. A method of protecting a loan owner and a borrower against a decrease in property value, the method comprising the steps of:
determining a value of a property being purchased based on an index for real estate where the property is located;
purchasing enough put option contracts on that index;
combining the contracts into a mortgage account taken by the borrower, the loan being structured so that if the put option contracts are sold or exercised the borrower receives the benefit, unless the borrower has defaulted, at which point the loan owner would receive the benefit; and
selectively selling the contracts and purchasing new contracts.

11. The method according to claim 10, wherein the property value is associated to the Chicago Mercantile Exchange Real Estate Index for a region the property is located in or near.

12. The method according to claim 10, wherein the step of combining the contract with a loan includes adding the cost of the put option contract to the principal amount of the loan.

13. The method according to claim 10, wherein the step of combining the contract with a loan includes classifying the cost of the put option contract as a closing cost to be paid at closing of the loan.

14. The method according to claim 10, wherein the purchasing step includes purchasing enough put option contracts to appropriately hedge the property value at the time of purchase.

15. The method according to claim 10, further comprising the step of specifying a time period for which the put option contract runs.

16. A mortgage product for real property, comprising:
a loan; and
put option contracts on a real estate index for a region in which the real property is located, whereby the option contract pays a borrower, or an owner of loan in case of default, if exercised or sold.

17. The mortgage product according to claim 16, wherein the property value is determined from the Chicago Mercantile Exchange Real Estate Index.

18. The mortgage product according to claim 16, wherein the combined put option contracts are for a hedge amount equal to the property value at the time of purchase.

19. A method of transforming a conventional mortgage into an equity-protected mortgage product; comprising the steps of:
creating a loan for a portion of a purchase price of a property;
associating the purchase price of the property to a current index price for real estate in or near a region where the property is located;
purchasing at least one put option contract on the index; and
combining the loan and the contract into one mortgage account to form the equity-protected mortgage product, whereby when there is a decline in the index the contract can be sold or exercised on the expiry date so as to protect both mortgagor and mortgagee against market depreciation and a likelihood of default.

20. A system for creating an equity-protected mortgage offering for a property comprising a computer having a processor, a network interface, a storage device, and a computer readable medium encoding a computer program, the computer being configured to execute the computer program encoded in the computer readable medium and the computer program configured to:
receive a request for the equity-protected mortgage for a prospective mortgagor, the request including a purchase price;
create a loan for a portion of a purchase price of a property;
associate the purchase price of a property with a current index price for real estate in a region where the property is located;
compute a number of put option contracts on the index required to provide a desired level of protection against a decrease in the index price for real estate, the computation based on at least the purchase price;
combine the loan and the computed number of put option contracts into one mortgage account to form an equity-protected mortgage offering.

21. The system of claim 20, wherein the computer program is further configured to:
obtain financial details regarding the prospective mortgagor;
analyze at least one of the obtained financial details; and
compute a minimum level of protection required based on the analysis of the obtained financial details,
wherein the desired level of protection is at least the minimum level of protection

22. The system of claim 21, wherein the financial details include at least one of a mortgage history, a credit score, an equity level in the property, and a cash reserve.

23. The system of claim 21, wherein the computer program is further configured to receive a preferred risk level from the prospective mortgagor, and the computed number of put option contracts is further based on the preferred risk level.

24. The system of claim 21, wherein the desired level of protection is based on at least the volatility of the index of real estate prices in the region.

25. The system of claim 21, wherein the desired level of protection is based on at least the time period for which the put option contract runs.

26. A system for trading an equity-protected mortgage comprising a computer having a processor, a network interface, a storage device, and a computer readable medium encoding a computer program, the computer being configured to execute the computer program encoded in the computer readable medium and the computer program configured to:
receive a request for the equity-protected mortgage for a property, the request including a purchase price of the property, a region of the property, a loan, and a desired level of protection;
retrieve an index price for real estate in the region of the property;
compute a first number of put option contracts on the index price required to provide a desired level of protection against a decrease in the index price for real estate, the computation based on at least the purchase price;
determine a second number of put option contracts based at least on the first number of put option contracts.
purchase a second number of option contracts on the index; and
combine the loan and the first number of put option contracts into one mortgage account.

27. The system of claim 26, wherein computer program is further configured to place the purchased put option contracts in trust.

28. The system of claim 26, further comprising a data storage device communicably connected to the computer, the data storage device storing information regarding a trading portfolio including put option contracts for one or more real estate index prices.

29. The system of claim 28, wherein the computer program is further configured to:
determine a third number of put option contracts for the real estate index price of the region of the property, the third number of put option contracts being a current trading portfolio position in the real estate index,
wherein the second number of put option contracts is further based on the third number of put option contracts.

30. The system of claim 29 wherein the second number of put option contracts is less than the first number of put option contracts.

31. The system of claim 26, wherein the computer program is further configured to publish a plurality of available put option contract prices to mortgage lenders, each respective published put option contract price being determined based on the real estate index price for a particular region.

32. The system of claim 31, wherein each respective published put option contract price is further based on at least one of the length of the respective contract, and the volatility of the respective real estate index.

33. A method for creating an equity-protected mortgage offering for a property comprising the steps of:
receiving a request for the equity-protected mortgage for a prospective mortgagor, the request including a purchase price;
creating a loan for a portion of a purchase price of a property;
associating the purchase price of a property with an index price for real estate in a region where the property is located;
computing a number of put option contracts on the index required to provide a desired level of protection against a decrease in the index price for real estate, the computation based on at least the purchase price;
combining the loan and the computed number of put option contracts into one mortgage account to form an equity-protected mortgage offering.

34. The method of claim 33, further comprising the steps of:
obtaining financial details regarding the prospective mortgagor;
analyzing at least one of the obtained financial details; and
computing a minimum level of protection required based on the analysis of the obtained financial details,
wherein the desired level of protection is at least the minimum level of protection

35. The method of claim 34, wherein the financial details include at least one of a mortgage history, a credit score, an equity level in the property, and a cash reserve.

36. The method of claim 34, further comprising the step of receiving a preferred risk level from the prospective mortgagor, wherein the computed number of put option contracts is further based on the preferred risk level.

37. The method of claim 34, wherein the desired level of protection is based on at least the volatility of the index of real estate prices in the region.

38. The method of claim 34, wherein the desired level of protection is based on at least the time period for which the put option contract runs.

39. A method for trading an equity-protected mortgage associated with a property in a region comprising the steps of:
receiving a request for the equity-protected mortgage associated with the property, the request including a purchase price of the property, a region of the property, a loan, and a desired level of protection;
retrieving an index price for real estate in the region of the property;
computing a first number of put option contracts on the index required to provide a desired level of protection against a decrease in the index price for real estate, the computation based on at least the purchase price;
determining a second number of put option contracts based at least on the first number of put option contracts.
purchasing a second number of option contracts on the index; and
combining the loan and the first number of put option contracts into one mortgage account.

40. The method of claim 39, further comprising the step of placing the purchased put option contracts in trust

41. The method of claim 39, further comprising the step of storing information regarding a trading portfolio including put option contracts for one or more real estate index prices in a computer storage device.

42. The method of claim 41, further comprising the step of determining a third number of put option contracts for the real estate index price of the region of the property, the third number of put option contracts being a current trading portfolio position in the real estate index, wherein the second number of put option contracts is further based on the third number of put option contracts.

43. The method of claim 42, wherein the second number of put option contracts is less than the first number of put option contracts.

44. The method of claim 39, further comprising the steps of:
computing a plurality of available put option contract prices based at least on the real estate index price for a particular region; and
publishing the plurality of available put option contract prices to mortgage lenders.

45. The method of claim 44, wherein each of the computed plurality of available put option contract prices are further based on at least one of the length of the respective contract, and the volatility of the respective real estate index.
